(19) United States
(12) Patent Application Publication
(10) Pub. No.: US 2013/0191164 A1
(43) Pub. Date: Jul. 25, 2013

(54) Portable Health Communication Apparatus and Watch

(71) Applicant: HUAWEI TECHNOLOGIES CO., LTD., Shenzhen (CN)

(72) Inventors: Jinchuan Xu, Shenzhen (CN); Changcheng Wen, Shenzhen (CN)

(73) Assignee: HUAWEI TECHNOLOGIES CO., LTD., Shenzhen (CN)

(21) Appl. No.: 13/793,731

(22) Filed: Mar. 11, 2013

Related U.S. Application Data
(63) Continuation of application No. PCT/CN2011/074670, filed on May 25, 2011.

(30) Foreign Application Priority Data
Sep. 13, 2010 (CN) 201010281199.1

(51) Int. Cl. G06F 19/00

(52) U.S. Cl. CPC G06F 19/322
USPC 705/3

(57) ABSTRACT

A portable health communication apparatus and a watch are provided, where the portable health communication apparatus includes: a receiving module configured to receive user health information and send the user health information to a processing module; the processing module configured to update the user health information into the storage module and upload the user health information to an external device through an external communication module, where the processing module is further configured to receive user health information in the external device through the external communication module and update user health information stored in the storage module; and an information presentation module configured to present, under the control of the processing module, the user health information stored in the storage module, so that rescue personnel may rescue a user according to the user health information when an emergency occurs.

### CROSS-REFERENCE TO RELATED APPLICATIONS

This application is a continuation of International Application No. PCT/CN2011/074670, filed on May 25, 2011, which claims priority to Chinese Patent Application No. 201010281199.1, filed on Sep. 13, 2010, both of which are hereby incorporated by reference in their entireties.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The embodiments of the present invention relate to the field of communications technologies, and in particular, to a portable health communication apparatus and a watch.

### BACKGROUND

Electronic health (eHealth) is an interdisciplinary outcome of gradual integration between microelectronics and information sciences, and life sciences, an outcome of integration between modern information and communication technologies (ICT) and digital medical technologies, and an outcome of integration between hospital informatization and social informatization, and its connotation and denotation are extended continuously with the improvement of science and technology, and the development of health service.

In the field of electronic health, a personal health record may be established by using a physiological indicator collection instrument to report collected data to a server, and archiving and managing the collected data in an electronic health information system (EHR).

In the prior art, the physiological indicator collection instrument may establish a connection with a health communication gateway through a bluetooth technology, and send detected data to a server through the health communication gateway. When a medical institution and an individual need to use some data, they may query the server for the data.

The prior art has the following problem: Because a personal health record is stored in a server, when an emergency happens to a person and a network cannot be accessed at that time, medical staff cannot obtain related health information of the patient from the server, thereby delaying the rescue.

### SUMMARY

Embodiments of the present invention provide a portable health communication apparatus and a watch, so as to solve a problem that in the prior art, health information of a patient cannot be obtained when a network cannot be accessed.

An embodiment of the present invention provides a portable health communication apparatus, including a receiving module, a storage module, a processing module, an external communication module, and an information presentation module; where the receiving module is configured to receive user health information and send the user health information to the processing module; the processing module is configured to receive the user health information sent by the receiving module, update the user health information into the storage module, and upload the user health information to an external device through the external communication module; the processing module is further configured to receive user health information in the external device through the external communication module, and update the user health information stored in the storage module; and the information presentation module is configured to present, under the control of the processing module, the user health information stored in the storage module, so that rescue personnel rescue a user according to the user health information when an emergency occurs.

An embodiment of the present invention further provides a watch, including a watch body, and further includes a mode switching module and the foregoing portable health communication apparatus, where the mode switching module is connected to the watch body and the portable health communication apparatus respectively, and is configured to, according to a received instruction, control the watch body to display time through an information presentation module in the portable health communication apparatus, or control the portable health communication apparatus to display user health information through the information presentation module.

With the portable communication apparatus and the watch that are provided in the embodiments of the present invention, the storage module stores the latest current user health information. Therefore, when a user is in an emergency state, even if a network cannot be accessed, medical staff or other personnel may also take a best rescue measure according to the user health information stored in the storage module, thereby saving rescue time and improving rescue efficiency.

### BRIEF DESCRIPTION OF THE DRAWINGS

To describe the technical solutions in the embodiments of the present invention or in the prior art more clearly, the accompanying drawings required for describing the embodiments or the prior art are introduced briefly in the following. Apparently, the accompanying drawings in the following description are only some embodiments of the present invention, and persons of ordinary skill in the art may also derive other drawings from these accompanying drawings without creative efforts.

FIG. 1 is a schematic structural diagram of a portable health communication apparatus according to a first embodiment of the present invention;

FIG. 2 is a schematic structural diagram of a portable health communication apparatus according to a second embodiment of the present invention;

FIG. 3 is a schematic structural diagram of a portable health communication apparatus according to a third embodiment of the present invention;

FIG. 4 is a schematic structural diagram of a watch according to a fourth embodiment of the present invention; and

FIG. 5 is a specific schematic structural diagram of a watch according to the fourth embodiment of the present invention.

### DETAILED DESCRIPTION

In order to make the objectives, technical solutions, and advantages of the embodiments of the present invention clearer, the technical solutions in the embodiments of the present invention are clearly and completely described in the following with reference to the accompanying drawings in the embodiments of the present invention. Apparently, the embodiments in the following description are merely a part rather than all of the embodiments of the present invention. Based on the embodiments of the present invention, all other embodiments obtained by persons of ordinary skill in the art without creative efforts shall fall within the protection scope of the present invention.

### Embodiment 1

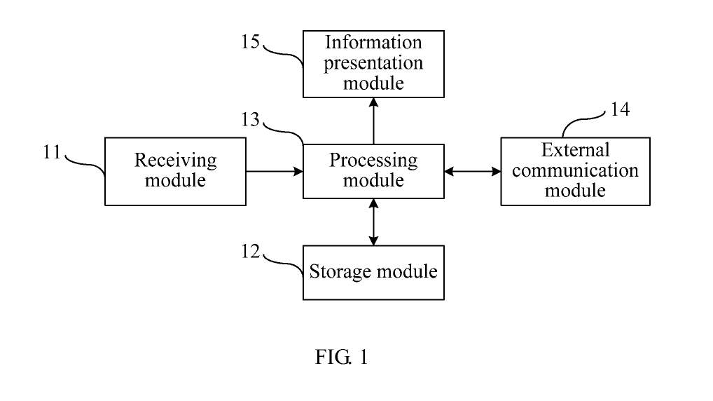

FIG. 1 is a schematic structural diagram of a portable health communication apparatus according to a first embodiment of the present invention. The apparatus includes a receiving module 11, a storage module 12, a processing module 13, an external communication module 14, and an information presentation module 15.

The receiving module 11 is configured to receive user health information and send the user health information to the processing module 13.

The processing module 13 is configured to receive the user health information sent by the receiving module 11, update the user health information into the storage module 12, and upload the user health information to an external device through the external communication module 14; the processing module 13 is further configured to receive user health information in the external device though the external communication module 14, and update user health information stored in the storage module 12; and the information presentation module 15 is configured to present, under the control of the processing module 13, the user health information stored in the storage module 12, so that rescue personnel may rescue a user according to the user health information when an emergency occurs.

A working principle of the portable health communication apparatus provided in this embodiment of the present invention is described in the following.

The user health information may include various items of physiological indicator data of a user, such as blood pressure, blood sugar, and electrocardiogram, and may further include basic information of the user (such as name, age, contact information, and major medical history) as well as advice and evaluation results that are made by medical staff on the health of the user.

To be convenient for portable use for the user, in this embodiment of the present invention, a certain requirement is imposed on volume and quality. Therefore, in this embodiment of the present invention, various physiological indicator detection units are not internally disposed, but detection and acquisition are implemented through various existing physiological indicator collection instruments. After detecting various items of physiological indicator data of the user, a physiological indicator collection instrument transmits the data to the portable health communication apparatus in this embodiment of the present invention.

Similarly, in view of portability, in this embodiment of the present invention, communication may be performed through a short-distance wireless communication manner, so that no cable needs to be carried, thereby making the use more convenient. Definitely, in this embodiment of the present invention, communication that is performed through a wired manner is not limited. However, for portability of a device, some communication interfaces that have little impact on volume and weight of the device should be used, for example, interfaces such as universal serial bus (USB) interfaces (including mini-USB or micro-USB interfaces) may be used to implement wired communication.

After collecting data, various external physiological indicator collection instruments send collected various items of physiological indicator data to the receiving module 11 (including various interfaces and being capable of implementing corresponding communication protocol processing) through the foregoing described wireless or wired manner. The physiological indicator collection instrument may also send detected user health information to the receiving module 11 through a wired connection. In addition, the receiving module 11 may also receive other user health information sent by other apparatuses, for example, may receive basic user information sent by other apparatuses, or other information that needs to be stored, which is not limited here.

After receiving the user health information, the receiving module 11 sends the user health information to the processing module 13. The processing module 13 updates the user health information into the storage module 12, that is, stores the latest current user health information in the storage module 12. Because the user health information may include multiple items and the user health information, especially various items of physiological indicator data of the user, may also change in real time, previously stored information needs to be replaced by the latest current user health information when the user health information is stored. For example, at a certain moment, data obtained by the user through a blood pressure gauge is that systolic pressure is 124 millimeters of mercury (mmHg) and diastolic pressure is 81 mmHg respectively, but the previously stored data is that systolic pressure is 130 mmHg and diastolic pressure is 80 mmHg, therefore, data corresponding to blood pressure in the user health information needs to be stored as 124 mmHg for systolic pressure and 81 mmHg for diastolic pressure. To form user health information more accurately, storage time may further be recorded in the storage module 12, and in this way, during query, medical staff may know clearly when the item of the user health information is formed.

To facilitate management and storage, a format requirement of the storage may be designed in advance, for example, a data format of the user health information during the storage, and storage space that is corresponding to various kinds of user health information may be designed. In this embodiment of the present invention, the processing module 13 further uploads the user health information to an external device through the external communication module 14. The external device may include a device such as a server, a USB flash disk, a mobile hard disk, or a personal computer (PC) that is independent of the portable health communication apparatus shown in FIG. 1. The external device may be used for storage only (such as a USB flash disk and a mobile hard disk), and may also be used to perform an operation on a part in the portable health communication apparatus (such as a server and a PC). In this way, a copy of user health information is also formed in the external device. The external device may update the user health information stored in the portable health communication apparatus, so that a patient may finish updating the user health information at a different place, thereby improving convenience of use.

In another aspect, medical staff may also query the external device for the user health information and then make evaluation or give advice on a health condition of the user, for example, an evaluation result that may be formed is: secondary hypertension, type I diabetes, penicillin allergy, and so on, thereby implementing remote management of a health condition of a patient.

After forming the evaluation or advice on the health condition of the user according to the user health information in the external device, the medical staff may also input the evaluation or advice into the external device, so that updated user health information is formed in the external device. The external device may interact with the processing module 13 through the external communication module 14 to update the user health information in the storage module 12. The interaction may be initiated by the external device (for example, performing remote control through a server), and may also be initiated by the portable health communication apparatus (for example, after detecting a USB flash disk, reading related information in the USB flash disk), which is not limited here. In a process of updating the user health information, changed user health information, added user health information, or other information that needs to be updated may be updated, which is also not limited here. After the user health information in the external device is changed, an update prompt message may be generated, and the update prompt message is sent to the portable health communication apparatus. After receiving the update prompt message, the portable health communication apparatus may establish a connection with the external device and receive updated user health information from the external device. After the update succeeds or fails, prompt information of successful or failed update may also be generated to avoid a problem that a patient does not know whether the update succeeds or not and always uses old data, so that the use is affected. If the update fails, the update may be performed by choosing a manner such as retransmission until it is updated to the latest data.

If an emergency happens to a user, for example, the user suffers a sudden heart attack, when medical staff or other personnel reach the user, user health information stored in the storage module 12 may be presented through the information presentation module 15 (or the information presentation module 15 may be enabled to present the user health information through some operations, for example, pressing a certain button). In this way, the medical staff or other personnel may obtain the latest user health information of the user quickly, and can take a best rescue measure according to the user health information, thereby saving rescue time and improving rescue efficiency.

The information presentation module 15 in this embodiment of the present invention may be an image information presentation module, or may be a sound information presentation module; alternatively, the information presentation module may include both an image information presentation module and a sound information presentation module.

The image presentation module may include a display screen, and the processing module displays, through the display screen, the user health information stored in the storage module, for example, according to a size (or resolution) of the screen, selectively, all information may be displayed in one time (the size or resolution of the screen meets a requirement for full display in one time), or information is displayed through rolling or splitting the screen (the size or resolution of the screen does not meet the requirement for full display in one time).

The sound information presentation module may include a voice apparatus (such as a loudspeaker), and the processing module expresses the user health information stored in the storage module through the voice apparatus. Specifically, the voice apparatus may simulate human voice to describe the user health information.

In this embodiment of the present invention, the information presentation module may include the image information presentation module and the sound information presentation module at the same time, and the two modules work simultaneously in use. In this way, reliability of the portable health communication apparatus may be improved. When an emergency which is usually accompanied by accidents such as a tumble and bump happens to a user, because the portable health communication apparatus is usually carried by the user, either the image information presentation module or the sound information presentation module is possibly damaged (for example, the display screen is broken, and an image or a text cannot be displayed). If the portable health communication apparatus is disposed with either the image information presentation module or the sound information presentation module, once the module is broken, the medical staff or other personnel cannot obtain the user health information in the storage module. If the portable health communication apparatus is disposed with the image information presentation module and the sound information presentation module at the same time, even if one of the modules is broken, the user health information in the storage module may still be obtained through the other continually working module, thereby improving the reliability of the apparatus.

With the portable health communication apparatus provided in this embodiment of the present invention, the receiving module may receive user health information collected by various physiological indicator collection instruments, while the apparatus itself does not need to be equipped with these physiological indicator collection instruments. Therefore, the volume of the apparatus may be smaller to meet a portability requirement.

The processing module in the portable communication apparatus may not only update the user health information received by the receiving module into the storage module, but also update user health information returned by the external device into the storage device. In this way, the user health information stored in the storage module can reflect the latest current physiological state of the user and can reflect an evaluation result and advice that are updated by the medical staff into the external device. Because the storage module of the portable communication apparatus stores the latest current user health information, when a user is in an emergency state, even if a network cannot be accessed, the medical staff or other personnel may also take a best rescue measure according to the user health information stored in the storage module, thereby saving the rescue time and improving the rescue efficiency.

Meanwhile, when the information presentation module includes the image information presentation module and the sound information presentation module at the same time, in the case that one module is broken, the other module may be used to continue working, thereby improving the reliability of the apparatus.

### Embodiment 2

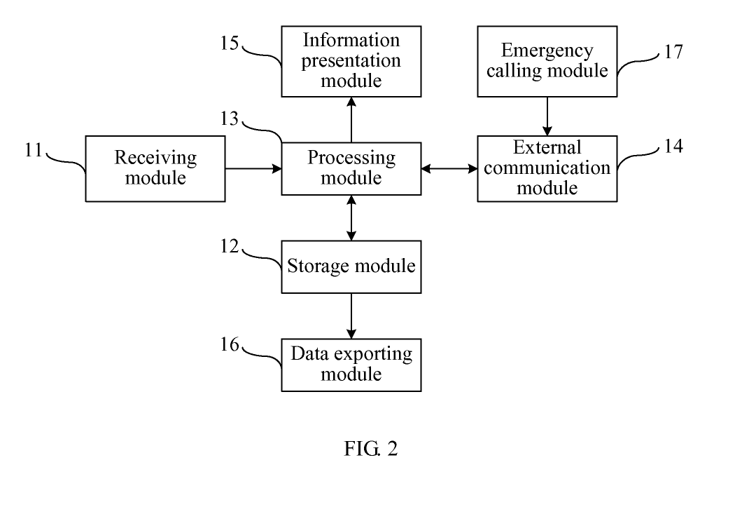

FIG. 2 is a schematic structural diagram of a portable health communication apparatus according to a second embodiment of the present invention. Based on the first embodiment, in the second embodiment, a data exporting module 16 and an emergency calling module 17 are added. The data exporting module 16 is connected to a storage module 12 and is configured to export user physiological data stored in the storage module 12 (for example, export data through a USB interface). The emergency calling module 17 may be connected to an external communication module 14, and may trigger the external communication module 14 to establish a connection with an external communication device, for example, establish a connection with a communication device of a rescue unit such as an emergency center. In this way, when an emergency happens to a user, the user may be rescued in time. To meet a requirement of an “emergency call,” the emergency calling module 17 usually includes a hardware apparatus which is easy to be triggered, for example, a trigger button. Definitely, to avoid unnecessary false triggering in daily life, the button may be in such design that triggering is performed only when a certain pressure is satisfied, or may be disposed with some protective apparatuses (for example, a cover) to avoid false triggering in daily life.

With the portable health communication apparatus provided in the second embodiment of the present invention, the data exporting module exports user health information. In this way, the user health information may be obtained without accessing an external device, thereby facilitating analysis and processing on the user health information.

With the portable health communication apparatus provided in this embodiment of the present invention, if data is not exported by using the data exporting module shown in FIG. 2, the storage module 12 may also be set to a structure that is similar to that of a tag in a radio frequency identification (RFID) system. In this manner, after entering a magnetic field, a storage receives a radio frequency signal transmitted by a reader, and sends out stored user health information by using energy obtained through an induced current. Similarly, the storage module 12 may also be set to a structure that is similar to that of an integrated circuit (IC) card. A frequency of the storage module 12 is the same as a frequency transmitted by the reader. In this way, in excitation of an electromagnetic wave, an inductor-capacitor (LC) resonant circuit in the storage module 12 generates resonance, so that an electric charge is generated in a capacitor. The other end of this electric charge is connected to an electronic pump with unidirectional continuity, where the electronic pump transmits the electric charge in the capacitor to another capacitor for storage. When accumulated electric charges reach 2 volts (V), the capacitor may be used as a power source to provide a working voltage to another circuit, so as to transmit the user health information in the storage module.

### Embodiment 3

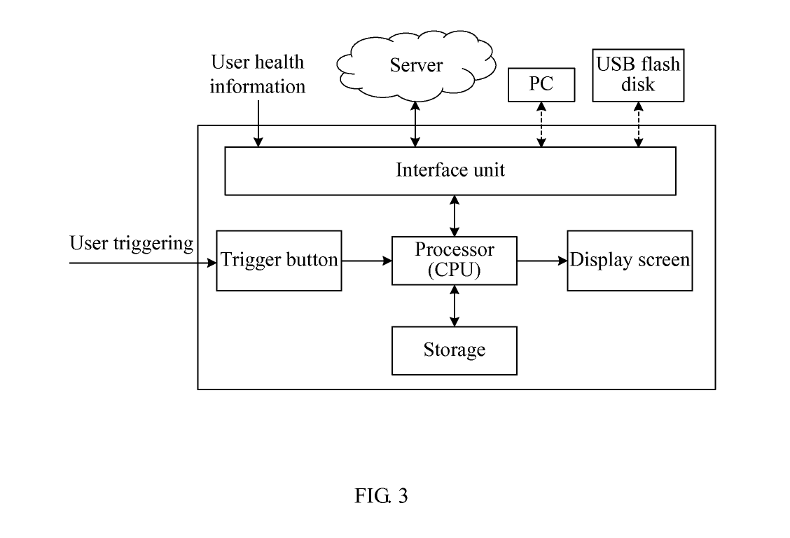

Based on the foregoing embodiment, an embodiment of the present invention provides a portable health communication apparatus. Referring to FIG. 3, this embodiment of the present invention includes a processor (for example, a central processing unit (CPU)), an interface unit, a storage, a trigger button, and a display screen.

The processor may adopt a chip that has a processing capability, for example, may adopt components such as a CPU, a single chip microcomputer, a digital signal processor (DSP), and so on, which is not limited here.

Being relative to the processor, the storage may be externally disposed, and may also be integrated in the processor. According to a system design requirement (such as capacity and cost), a storage that is internally or externally disposed may be adopted. As regards a specific type, the storage may be a nonvolatile storage, such as a flash, which is not limited here either.

The interface unit is configured to provide a specific interface for wireless communication or wired communication, and may receive user health information, or communicate with external devices such as a server, a PC, and a USB flash disk. For a specific form, reference may be made to the description in the foregoing embodiment, which is not described here again.

The trigger button is configured to receive trigger commands of a user, so that the processor performs corresponding operations according to these commands, for example, to display user health information, or make an emergency call.

The display screen is configured to display information that needs to be displayed, and is controlled by the processor.

In the foregoing embodiments, all functions that require computing processing in the processing module, the receiving module, the external communication module, the information presentation module, the emergency calling module, the data exporting module, and the storage module may be implemented by a processor (for example, a CPU); and definitely, if some chips have processing functions by themselves, corresponding processing may be implemented by these chips, which is not limited in the embodiments of the present invention.

### Embodiment 4

Based on the foregoing embodiment, an embodiment of the present invention provides a watch, and the watch is integrated with the foregoing portable health communication apparatus.

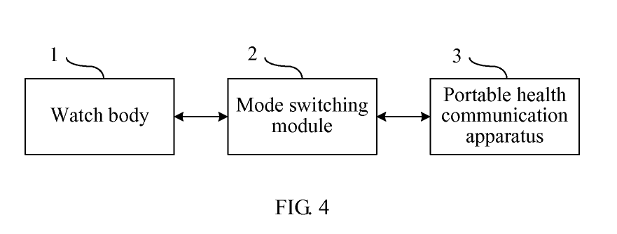

FIG. 4 is a schematic structural diagram of a watch according to a fourth embodiment of the present invention. The watch includes a watch body 1, a mode switching module 2, and the portable health communication apparatus 3 described in each foregoing embodiment, where the mode switching module 2 is connected to the watch body 1 and the portable health communication apparatus 3, respectively. The mode switching module 2 is configured to, according to a received instruction, control the watch body 1 to display time through an information presentation module in the portable health communication apparatus 3, or control the portable health communication apparatus 3 to display user health information through the information presentation module.

In a specific implementation process, if the portable health communication apparatus 3 is implemented by using hardware shown in the third embodiment, the mode switching module 2 may also be implemented by the processor in the third embodiment. Here, separate descriptions of the mode switching module 2 and the portable health communication apparatus 3 only indicate that the two modules are independent in terms of function, and do not indicate that the two modules are independent hardware in hardware implementation. Definitely, a function of the mode switching module 2 may also be implemented through a combination of another processor chip with other hardware circuits, which is not limited in this embodiment of the present invention.

In this embodiment, both the watch and the portable health communication apparatus achieve a display purpose through the information presentation module, and the information presentation module may display information by using a display screen.

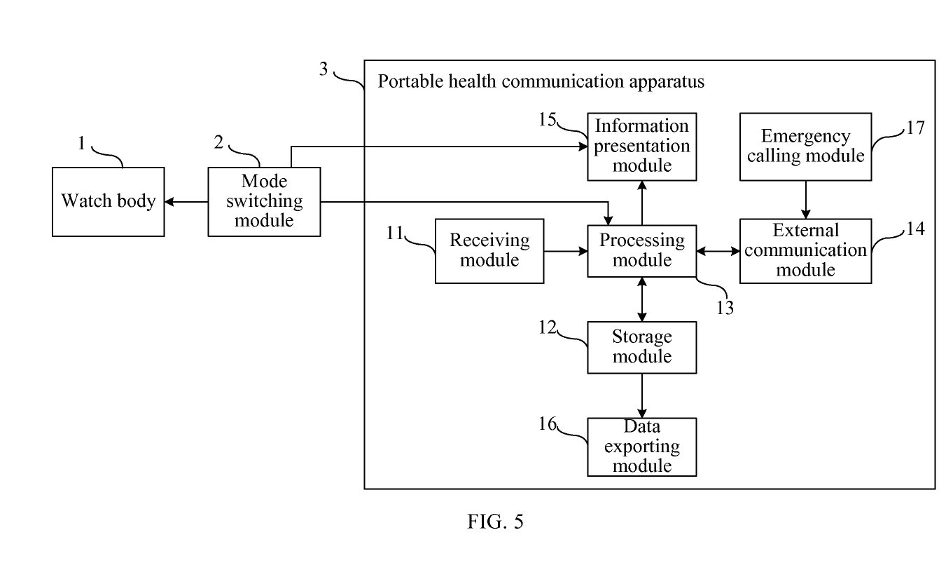

FIG. 5 is a specific schematic structural diagram of a watch according to the fourth embodiment of the present invention. A portable health communication apparatus in this embodiment adopts a structure in the embodiment shown in FIG. 2. Through the schematic diagram shown in FIG. 5, connection relationships among modules in a watch body 1, a mode switching module 2, and a portable health communication apparatus 3 may be seen more clearly, where the mode switching module 2 is connected to a processing module 13 and an information presentation module 15 respectively.

In FIG. 5, an emergency calling module 17 in the portable health communication apparatus 3 may be set as a button on the watch. Once an emergency occurs, the button may be pressed to trigger an external communication module to connect an emergency center to get aid in time.

With the watch provided in the embodiment of the present invention, through the mode switching module, the watch can display time and also can display user health information. During an outdoor activity of a user, user health information may also be stored in the storage module in time if necessary, which meets a portability requirement. In addition, even if a user goes to a place where a network cannot be accessed, medical staff or other personnel may still take a beset rescue measure through user health information stored in the watch, thereby saving rescue time.

Persons of ordinary skill in the art may understand that all or a part of the steps of the foregoing method embodiments may be implemented by a program instructing relevant hardware. The foregoing program may be stored in a computer readable storage medium. When the program runs, the steps of the foregoing method embodiments are performed. The foregoing storage medium may be any medium that is capable of storing program codes, such as a read-only memory (ROM), a random-access memory (RAM), a magnetic disk, or an optical disk.

Finally, it should be noted that the foregoing embodiments are merely used for describing the technical solutions of the present invention, but are not intended to limit the present invention. It should be understood by persons of ordinary skill in the art that although the present invention has been described in detail with reference to the foregoing embodiments, modifications may still be made to the technical solution described in each foregoing embodiment, or equivalent replacements may be made to some technical features in the technical solution, however, these modifications or replacements do not make the essence of a corresponding technical solution depart from the spirit and scope of the technical solution in each embodiment of the present invention.

What is claimed is:

1. A portable health communication apparatus comprising
a receiving module;
a storage module;
a processing module;
an external communication module; and
an information presentation module,
wherein the receiving module is configured to receive user health information and send the user health information to the processing module,
wherein the processing module is configured to receive the user health information sent by the receiving module, update the user health information into the storage module, and upload the user health information to an external device through the external communication module,
wherein the processing module is further configured to receive the user health information in the external device though the external communication module, and update the user health information stored in the storage module, and
wherein the information presentation module is configured to present, under the control of the processing module, the user health information stored in the storage module.

2. The portable health communication apparatus according to claim 1, wherein the information presentation module comprises an image information presentation module and/or a sound information presentation module.

3. The portable health communication apparatus according to claim 2, wherein the image information presentation module comprises a display screen, and wherein the sound information presentation module comprises a voice apparatus.

4. The portable health communication apparatus according to claim 2, wherein the information presentation module comprises both the image information presentation module and the sound information presentation module, wherein the image information presentation module and the sound information presentation module are configured to work simultaneously, and wherein when one of the information presentation module or the image information presentation module is broken, the other one of the information presentation module or the image information module continues to work.

5. The portable health communication apparatus according to claim 1, further comprising a data exporting module connected to the storage module and configured to export data stored in the storage module.

6. The portable health communication apparatus according to claim 1, further comprising an emergency calling module connected to the external communication module and configured to trigger the external communication module to establish a connection with an external communication device.

7. A watch comprising
a watch body;
a mode switching module; and
a portable health communication apparatus,
wherein the mode switching module is connected to the watch body and the portable health communication apparatus respectively,
wherein the mode switching module is configured to, according to a received instruction, control the watch body to display time through an information presentation module in the portable health communication apparatus, or control the portable health communication apparatus to display user health information through the information presentation module,
wherein the portable health communication apparatus comprises a receiving module, a storage module, a processing module, an external communication module, and the information presentation module,
wherein the receiving module is configured to receive the user health information and send the user health information to the processing module,
wherein the processing module is configured to receive the user health information sent by the receiving module, update the user health information into the storage module, and upload the user health information to an external device through the external communication module,
wherein the processing module is further configured to receive the user health information in the external device though the external communication module and update the user health information stored in the storage module, and
wherein the information presentation module is configured to present, under the control of the processing module, the user health information stored in the storage module.

8. The watch according to claim 7, wherein the information presentation module comprises an image information presentation module and/or a sound information presentation module.

9. The watch according to claim 8, wherein the image information presentation module comprises a display screen, and wherein the sound information presentation module comprises a voice apparatus.

10. The watch according to claim 8, wherein when the information presentation module comprises both the image information presentation module and the sound information presentation module, wherein the image information presentation module and the sound information presentation module are configured to work simultaneously, and wherein when one of the information module or the image information presentation module is broken, the other one of the information module or the image information presentation module continues to work.

11. The watch according to claim 7, wherein the portable health communication apparatus further comprising a data exporting module connected to the storage module and configured to export data stored in the storage module.

12. The watch according to claim 7, wherein the portable health communication apparatus further comprising an emergency calling module connected to the external communication module and configured to trigger the external communication module to establish a connection with an external communication device.
